(19) United States
(12) Patent Application Publication
(10) Pub. No.: US 2023/0177728 A1
(43) Pub. Date: Jun. 8, 2023

(54) COLOR MANAGEMENT CACHING FOR DISPLAY PROCESSING PIPELINES

(71) Applicant: Google LLC, Mountain View, CA (US)

(72) Inventors: Hyunchul Kim, San Jose, CA (US); Sang Young Youn, Cupertino, CA (US)

(21) Appl. No.: 17/997,109

(22) PCT Filed: Aug. 25, 2020
(86) PCT No.: PCT/US2020/070461

§ 371 Date: Oct. 25, 2022

(51) Int. Cl. G06T 7/90; G06T 1/20; G06T 1/60; G06F 3/14; G09G 3/3208

(52) U.S. Cl. CPC G06T 7/90; G06F 3/14; G06T 1/20; G06T 1/60; G09G 3/3208

(57) ABSTRACT

An example method includes obtaining a particular input color sample of a current line of samples rendered by a graphical processing unit (GPU) of the device; maintaining a cache that includes entries mapping input color samples to output interpolated color samples; determining whether the cache includes an entry corresponding to the particular input color sample; responsive to determining that the cache includes an entry corresponding to the particular input color sample, outputting, by the processing circuitry, a particular output interpolated color sample included in the entry corresponding to the particular input color sample without performing interpolation on the particular input color sample; and displaying, at a display of the device, a representation of the particular output interpolated color sample.

### BACKGROUND

Computing devices may include display processing pipelines, also known as image processing pipelines, that process image data for output at a display device. Some display processing pipelines may include color management (CM) processing functionality. CM processing may enable a consistent experience across display technologies such as active-matrix organic light emitting diode (OLED) display devices and liquid crystal display (LCD) devices.

### SUMMARY

In general, aspects of this disclosure are directed to techniques for reducing an amount of power consumed to perform CM processing. To perform CM processing, one or more processors of a display processing pipeline may receive an input color sample (e.g., an R/G/B value) from an earlier block of the pipeline. The one or more processors may utilize a three-dimensional (3D) lookup table (LUT) with interpolation to map the input color sample to an output color sample in lattice points of a 3D table, where a non-lattice point is interpolated based on lattice points nearest to the non-lattice point. However, such interpolation may consume a significant amount of power. For instance, to interpolate a non-lattice point, the one or more processors may perform 8 random memory access operations, 8 multiplication operations, 32 addition operations, and 3 division operations.

In accordance with one or more techniques of this disclosure, the one or more processors may utilize a cache that includes entries mapping input color samples to output interpolated color samples. When an input color sample matches an entry in the cache, the one or more processors may utilize the output color sample of the entry at the output color sample without having to perform interpolation. By avoiding having to perform interpolation, the amount of power consumed to perform CM processing may be significantly reduced. In one example, the amount of power consumed when using a cached interpolated sample may be 1/51 the amount of power consumed to perform interpolation. By reducing the amount of power consumed, battery life may be extended.

In one example, a method includes obtaining, by processing circuitry of a display image processing pipeline of a device, a particular input color sample of a current line of samples rendered by a graphical processing unit of the device; maintaining, by the processing circuitry, a cache that includes entries mapping input color samples to output interpolated color samples; determining, by the processing circuitry, whether the cache includes an entry corresponding to the particular input color sample; responsive to determining that the cache includes an entry corresponding to the particular input color sample, outputting, by the processing circuitry, a particular output interpolated color sample included in the entry corresponding to the particular input color sample without performing interpolation on the particular input color sample; and displaying, at a display of the device, a representation of the particular output interpolated color sample.

In another example, a device includes a display; and an image processing pipeline comprising circuitry configured to: obtain a particular input color sample of a current line of samples rendered by a graphical processing unit of the device; maintain a cache that includes entries mapping input color samples to output interpolated color samples; determine whether the cache includes an entry corresponding to the particular input color sample; output, responsive to determining that the cache includes an entry corresponding to the particular input color sample, a particular output interpolated color sample included in the entry corresponding to the particular input color sample without performing interpolation on the particular input color sample; and cause the display to output a representation of the particular output interpolated color sample.

In another example, a device includes means for means for obtaining a particular input color sample of a current line of samples rendered by a graphical processing unit of the device, means for maintaining a cache that includes entries mapping input color samples to output interpolated color samples; means for determining whether the cache includes an entry corresponding to the particular input color sample; means for outputting, responsive to determining that the cache includes an entry corresponding to the particular input color sample, a particular output interpolated color sample included in the entry corresponding to the particular input color sample without performing interpolation on the particular input color sample; and means for displaying a representation of the particular output interpolated color sample.

In another example, a non-transitory computer-readable storage medium stores instructions that, when executed, cause processing circuitry of an image processing pipeline to obtain a particular input color sample of a current line of samples rendered by a graphical processing unit of the device; maintain a cache that includes entries mapping input color samples to output interpolated color samples; determine whether the cache includes an entry corresponding to the particular input color sample; output, responsive to determining that the cache includes an entry corresponding to the particular input color sample, a particular output interpolated color sample included in the entry corresponding to the particular input color sample without performing interpolation on the particular input color sample; and cause a display to output a representation of the particular output interpolated color sample.

The details of one or more examples are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating a device that includes an image processing pipeline with caching to support color management, in accordance with one or more techniques of this disclosure.

FIG. 2 is a conceptual diagram illustrating one example of an image processing pipeline, in accordance with one or more techniques of this disclosure.

FIG. 3 is a conceptual diagram showing details of one example of a CM & interpolator, in accordance with one or more techniques of this disclosure.

FIG. 4 is a conceptual diagram illustrating one example of a cache address decoder, in accordance with one or more techniques of this disclosure.

FIG. 5 is a conceptual diagram showing details of one example of a CM & interpolator with dynamic cache updating, in accordance with one or more techniques of this disclosure.

FIG. 6 is a conceptual diagram showing further details of one example of a CM & interpolator with dynamic cache updating, in accordance with one or more techniques of this disclosure.

FIG. 7 is a flowchart illustrating example operations of an image processing pipeline that uses a cache to reduce power consumption of CM, in accordance with or more techniques of this disclosure.

### DETAILED ABSTRACT OF THE INVENTION

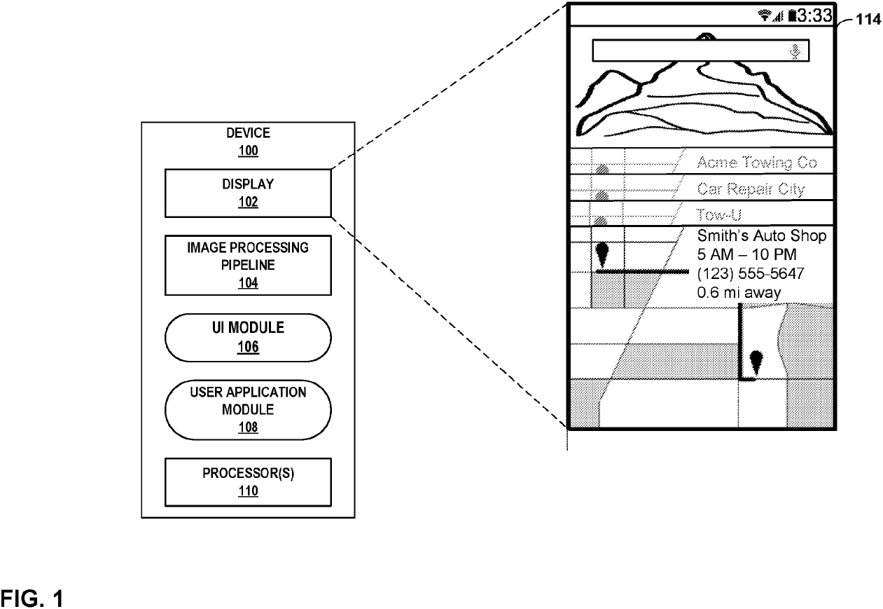

FIG. 1 is a block diagram illustrating a device that includes an image processing pipeline with caching to support color management, in accordance with one or more techniques of this disclosure. As shown in FIG. 1, device 100 includes display 102, image processing pipeline 104, user interface (UI) module 106, user application module 108, and one or more processors 110 (“processors 110”). In the example of FIG. 1, device 100 can be any device that includes a display. Examples of device 100 include, but are not limited to, a mobile phone, a camera device, a tablet computer, a smart display, a laptop computer, a desktop computer, a gaming system, a media player, an e-book reader, a television platform, a vehicle infotainment system or head unit, or a wearable computing device (e.g., a computerized watch, a head mounted device such as a VR/AR headset, computerized eyewear, a computerized glove).

Display 102 may be capable of rendering data into images viewable by a user of device 100. For example, display 102 may include a matrix of pixels that are individually controllable. Examples of display 102 include, but are not limited to, liquid crystal displays (LCD), light emitting diode (LED) displays, organic light-emitting diode (OLED) displays (including, for example, active-matrix organic light-emitting diode (AMOLED)), microLED displays, or similar monochrome or color displays capable of outputting visible information to a user of device 100. In some examples, display 102 may be a presence-sensitive display capable of detecting user input.

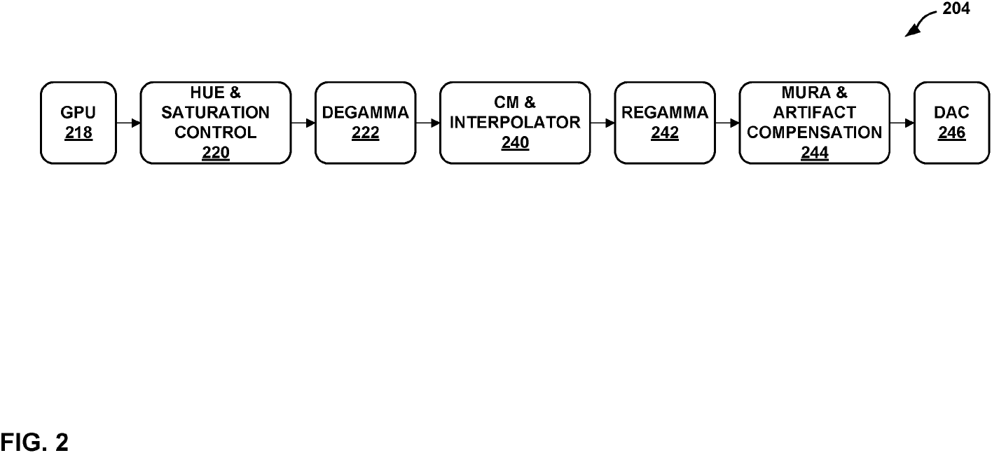

Image processing pipeline 104 may include one or more blocks that sequentially perform image processing operations on image data. Image processing pipeline 104, also referred to as display image processing pipeline 104, may include a graphical processing unit (GPU) that renders graphical instructions and textures into an array of color samples. Other blocks of image processing pipeline 104 may process the color samples and the fully processed samples may be output at display 102. One of the blocks of image processing pipeline 104 may be a color management (CM) block that performs CM processing (e.g., to enable a consistent experience across display technologies such as AMOLED display devices and LCD devices). Further details of one example of image processing pipeline 104 are discussed below with reference to FIG. 2.

UI module 106 manages user interactions with display 102 and other components of device 100. In other words, UI module 106 may act as an intermediary between various components of device 100 to make determinations based on user input detected by display 102 and cause image processing pipeline 104 to generate output at display 102 in response to the user input. UI module 106 may receive instructions from an application, service, platform, or other module of device 100 to cause display 102 to output a user interface. UI module 106 may manage inputs received by device 100 as a user views and interacts with the user interface presented at display 102 and update the user interface in response to receiving additional instructions from the application, service, platform, or other module of device 100 that is processing the user input.

User application module 108 may execute at device 100 to perform any of a variety of operations. Examples of user application module 108 include, but are not limited to, operating systems, music applications, photo viewing applications, mapping applications, electronic message applications, chat applications, Internet browser applications, social media applications, electronic games, menus, and/or other types of applications that may operate based on user input.

Processors 110 may implement functionality and/or execute instructions within device 100. Examples of processor(s) 110 include, but are not limited to, one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Device 100 may include modules 106 and 108. Modules 106 and 108 may perform operations described using software, hardware, firmware, or a mixture of hardware, software, and/or firmware residing in and/or executing at device 100. Device 100 may execute modules 106 and 108 with one or more processors. Device 100 may execute modules 106 and 108 as a virtual machine executing on underlying hardware. Modules 106 and 108 may execute as a service or component of an operating system or computing platform. Modules 106 and 108 may execute as one or more executable programs at an application layer of a computing platform. Modules 106 and 108 may be otherwise arranged remotely to and remotely accessible to device 100, for instance, as one or more network services operating at a network in a network cloud.

In operation, user application module 108 may cause image processing pipeline 104 render graphical user interface (GUI) 114 for output at display 102. For instance, as shown in the example of FIG. 1, user application module 108 may be a navigation application that outputs instructions to image processing pipeline 104 that cause image processing pipeline 104 to render graphical user interface 114 and output the rendered GUI for output at display 102.

As discussed above, image processing pipeline 104 may include a CM block that performs CM processing. To perform CM processing, the CM block of image processing pipeline may receive an input color sample (e.g., an R/G/B value) from an earlier block of image processing pipeline 104 and perform interpolation using a 3D lookup table (LUT) to map the input color sample to an output color sample. The 3D LUT may be a 17×17×17×3×10 bit (where the input color sample is a 10 bit per channel sample). One example of how such interpolation may be performed is described in Chapter 9 of “Computational Color Technology”, Henry R. Kang (Author) SPIE Publications (May 17, 2006), ISBN-13: 978-0819461193. Performing such interpolation may consume significant amounts of power, which may be of particular concern where device 100 is battery powered. For instance, to interpolate a single color sample, the CM block of image processing pipeline 104 may perform 8 random memory access operations, 8 multiplication operations, 32 addition operations, and 3 division operations.

In accordance with one or more techniques of this disclosure, the CM block of image processing pipeline 104 may utilize a cache that includes entries mapping input color samples to output interpolated color samples. When an input color sample matches an entry in the cache, the CM block of image processing pipeline 104 may utilize the output color sample of the entry at the output color sample without having to perform interpolation. However, when an input color sample does not many any entries in the cache, the CM block of image processing pipeline 104 may perform interpolation to generate an output interpolated color sample. By avoiding having to perform interpolation, the amount of power consumed to perform CM processing may be significantly reduced. In one example, the amount of power consumed when using a cached interpolated sample may be 1/51 the amount of power consumed to perform interpolation.

As discussed above, the CM block of image processing pipeline 104 may maintain a cache to reduce the number of times that interpolation is performed. In some examples, the entries in the cache may be static and predetermined. For instance, an analysis of processed color samples may be conducted to determine the N most commonly color samples. The N most commonly used color samples, along with precalculated corresponding interpolated output color samples, may be stored in the cache. In some examples, image processing pipeline 104 may store a plurality of caches, each cache of the plurality of caches corresponding to a different output scenario. Responsive to determining that the image being rendered corresponds to a particular output scenario, image processing pipeline 104 may utilize the cache corresponding to the particular output scenario. Some example output scenarios include, but are not limited to, social networking user interfaces, searching user interfaces, shopping user interfaces, work application user interfaces, application stores user interfaces, and the like (e.g., and dark modes of each scenario). In some examples, image processing pipeline 104 may determine which scenario is currently occurring based on an application type that is requesting the rendering and output of the user interface (e.g., an application type of user application module 108).

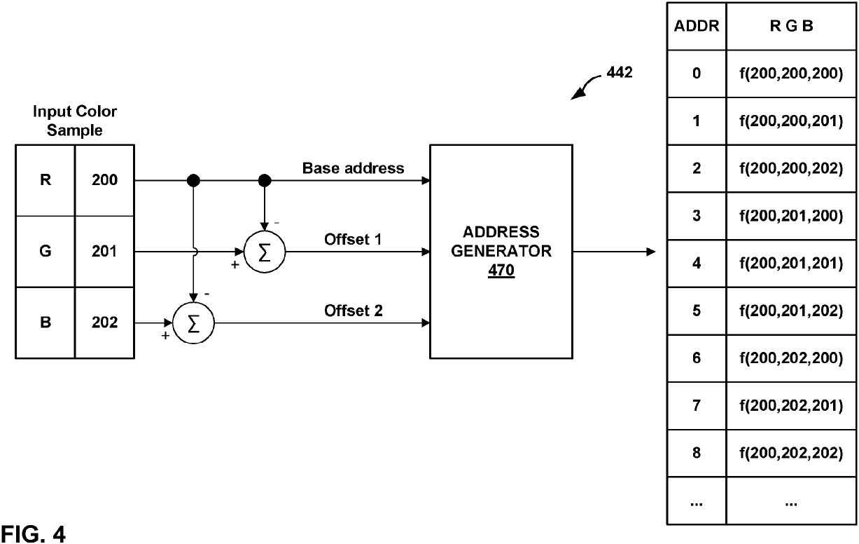

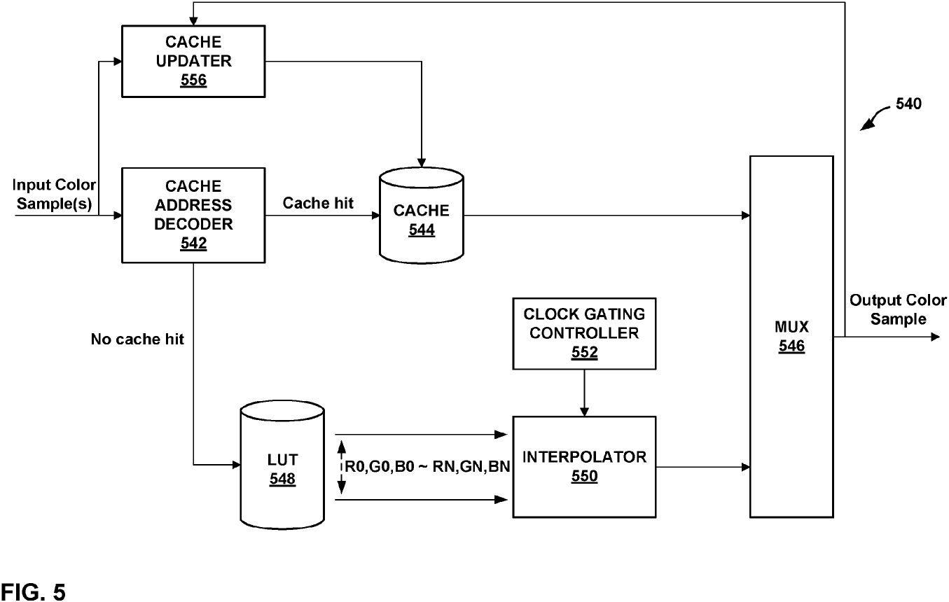

In some examples, the CM block of image processing pipeline 104 may dynamically update the entries in the cache. For instance, the CM block of image processing pipeline 104 may determine a quantity of input color samples of a current line of samples for which the cache includes corresponding entries (e.g., determine a cache hit rate). Responsive to determining that the determined quantity is less than a threshold quantity, the CM block of image processing pipeline 104 may update the entries of the cache based on the input color samples of the current line of samples. Further details of one example of dynamic cache updating are discussed below with reference to FIGS. 4 and 5.

FIG. 2 is a conceptual diagram illustrating one example of an image processing pipeline, in accordance with one or more techniques of this disclosure. Image processing pipeline 204 of FIG. 2 may be one example of image processing pipeline 104 of FIG. 1. As shown in FIG. 2, image processing pipeline 204 may include graphics processing unit (GPU) 218, hue & saturation control 220, degamma 222, CM & interpolator 240, regamma 242, mura & artifact compensation 244, and digital to analog converter (DAC) 246.

The components of image processing pipeline 204 may all be included on a single component (e.g., a single chip) or may be distributed across multiple components (e.g., across multiple chips). As one example, GPU 218 and hue & saturation control 220 may be included in a system on a chip (SoC) (e.g., of device 100) and degamma 222, CM & interpolator 240, regamma 242, mura & artifact compensation 244, and DAC 246 may be included in a display driver integrated circuit (DDIC) (e.g., of device 100). As another example, GPU 218, hue & saturation control 220, degamma 222, CM & interpolator 240, and regamma 242 may be included in the SoC and mura & artifact compensation 244, and DAC 246 may be included in the DDIC. It is noted that image processing pipeline 204 may include additional elements not shown (e.g., display stream compression (DSC)) or may not include some elements that are shown in FIG. 2 (e.g., mura & artifact compensation 244).

GPU 218 may render graphical instructions and textures into an array of output color samples. For instance, GPU 218 may receive instructions (e.g., from UI module 106 of FIG. 1) in OpenGL, OpenCL, DirectX, Direct3D, Vulkan, or any other application programming interface (API) that cause GPU 218 to generate an array of output color samples. GPU 218 may provide the array of output color samples to a subsequent block in image processing pipeline 204, such as hue & saturation control 220.

Hue & saturation control 220 may process input color samples received from a previous block in image processing pipeline 204 to adjust hue and saturation levels. For instance, hue & saturation control 220 may adjust hue and saturation levels of an input color sample received from GPU 218 to generate output color samples. Hue & saturation control 220 may provide the adjusted output color samples to a subsequent block in image processing pipeline 204, such as degamma 222.

Degamma 222 may process input color samples received from a previous block in image processing pipeline 204 to remove gamma. For instance, degamma 222 may convert a gamma encoded input color sample received from hue & saturation control 220 into an R,G,B output color sample. Degamma 222 may provide the R,G,B output color sample to a subsequent block in image processing pipeline 204, such as CM & interpolator 240.

CM & interpolator 240 may perform color management (CM) processing on input color samples received from a previous block in image processing pipeline 204. As discussed above, CM & interpolator 240 may perform the CM processing on an input color sample via interpolation using a 3D lookup table (LUT) to map the input color sample to an output color sample. As also discussed above, and in accordance with one or more techniques of this disclosure, CM & interpolator 240 may maintain a cache that includes entries mapping input color samples to output interpolated color samples. By using such a cache, CM & interpolator 240 may reduce the number of times that interpolation is performed, which may reduce power consumption. Regardless of obtaining the output color sample via interpolation or cache lookup, CM & interpolator 240 may provide the output color sample to a subsequent block of image processing pipeline 204, such as regamma 242.

Regamma 242 may perform an inverse operation to degamma 222. For instance, regamma 242 may convert a R,G,B encoded input color sample received from CM & interpolator 240 into a gamma encoded output color sample. Regamma 242 may provide the gamma encoded output color sample to a subsequent block in image processing pipeline 204, such as mura & artifact compensation 244.

Mura & artifact compensation 244 may process input color samples received from a previous block in image processing pipeline 204 to compensate for mura and artifacts of a display at which the color samples are to be output (e.g., display 102 of FIG. 1). For instance, mura & artifact compensation 244 may, based on known parameters of the display (e.g., one or more scans of the display as outputting test patterns), adjust the input color samples to generate output color samples in which the mura and artifacts appear to be “cancelled out.”

DAC 246 may convert input color samples into analog levels that correspond to the input color samples. For instance, DAC 246 may receive an input color sample as a 10bit per channel R,G,B value. DAC 246 may generate a first analog voltage signal that represents the R value, a second analog voltage signal that represents the G value, and a third analog voltage signal that represents the B value. DAC 246 may output the analog levels for output by a display, such as display 102 of FIG. 1.

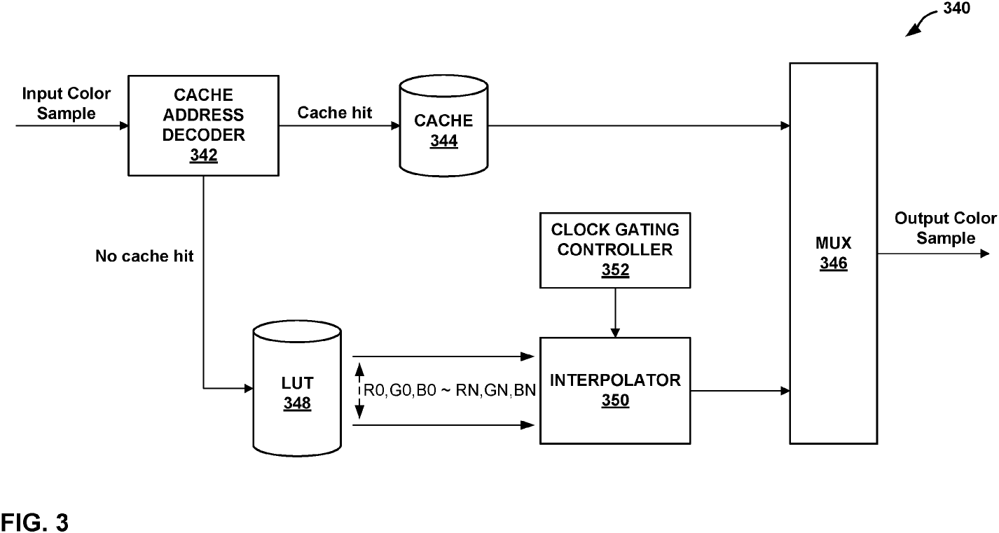

FIG. 3 is a conceptual diagram showing details of one example of a CM & interpolator, in accordance with one or more techniques of this disclosure. CM & interpolator 340 of FIG. 3 may be one example of CM & interpolator 240 of FIG. 2. As shown in FIG. 3, CM & interpolator 340 may include cache address decoder 342, cache 344, multiplexer 346, look-up table (LUT) 348, interpolator 350, and clock gating controller 352.

Cache address decoder 342 may be configured to determine an address in a cache, such as cache 344, based on an input color sample. Further details of one example of cache address decoder 342 are discussed below with reference to FIG. 4.

Cache 344 may be configured to store entries that map between input color samples and corresponding output CM color samples. The output CM color sample in a particular entry may be what would be output by interpolator 350 if interpolator 350 were to perform interpolation on an input color sample in the particular entry. A size of cache 344 may be selected to be significantly less than a size of LUT 348. For instance, if LUT 348 is 147 Kbit, cache 344 may be 54 Kbit.

Multiplexer (MUX) 346 may output one of a cache obtained output CM color sample or an interpolated CM color sample for each input color sample. For instance, where the input color sample matches an entry in cache 344, MUX 346 may output the CM color sample included in the entry in cache 344. On the other hand, where the input color sample does not match an entry in cache 344, MUX 346 may output the interpolated CM color sample generated by interpolator 350 based on the input color sample.

LUT 348 may represent a 3D look-up table with lattice points that may be used as anchor points for interpolating non-lattice points. Where the input color samples are 10-bit RGB color samples, LUT 348 may be a 17×17×17×3×10 bit (147 Kbit) LUT. As noted above, LUT 348 may be used in tandem with interpolator 350 as storing a full mapping between every possible input color sample and corresponding CM output color samples would occupy too much memory/storage space.

Interpolator 350 may be configured to interpolate a CM output color sample for an input color sample based on lattice points stored in LUT 348. For instance, LUT 348 may provide interpolator 350 with N lattice points that most closely match the input color sample (e.g., R0,G0,B0 ~ RN,GN,BN). Based on the N lattice points, LUT 348 may perform interpolation to generate a CM output color sample for the input color sample. In some examples, interpolator 350 may utilize trilinear interpolation, such as described in “Computational Color Technology”, Henry R. Kang (Author) SPIE Publications (May 17, 2006), ISBN-13: 978-0819461193. For instance, where N is 8, the obtained lattice points may be p₀₀₀, p₀₀₁, p₀₁₀, p₀₁₁, p₁₀₀, p₁₀₁, p₁₁₀, and p₁₁₁. Interpolator 340 may apply the following Equation 1 to obtain the CM output color sample:

$$\begin{matrix}p \left(x , y , z\right) = {c}_{0} + {c}_{1} Δ x + {c}_{2} Δ y + {c}_{3} Δ z + {c}_{4} Δ x Δ y + {c}_{5} Δ y Δ z + \\ {c}_{6} Δ z Δ x + {c}_{7} Δ x Δ y Δ z\end{matrix}$$

In the above equation, Δx, Δy, and Δz may be relative distances of the point with respect to starting point p₀₀₀ in the x, y, and z directions respectively as shown in the following Equations 2:

$$Δ x = \frac{\left(x - {x}_{0}\right)}{\left({x}_{1} - {x}_{0}\right)} ; Δ y = \frac{\left(y - {y}_{0}\right)}{\left({y}_{1} - {y}_{0}\right)} ; Δ z = \frac{\left(z - {z}_{0}\right)}{\left({z}_{1} - {z}_{0}\right)}$$

Interpolator 350 may determine values for coefficients cⱼ based on values of the vertices (e.g., based on the values of the lattice points obtained from LUT 348). For example, interpolator 350 may determine the values for coefficients cⱼ as shown in the following Equations 3:

$${c}_{0} = {p}_{000} ; {c}_{1} = \left({p}_{100} - {p}_{000}\right) ; {c}_{2} = \left({p}_{010} - {p}_{000}\right)$$

$${c}_{3} = \left({p}_{001} - {p}_{000}\right) ; {c}_{4} = \left({p}_{110} - {p}_{010} - {p}_{100} + {p}_{000}\right)$$

$${c}_{5} = \left({p}_{011} - {p}_{001} - {p}_{010} + {p}_{000}\right) ; {c}_{6} = \left({p}_{101} - {p}_{001} - {p}_{100} + {p}_{000}\right)$$

$${c}_{7} = \left({p}_{111} - {p}_{011} - {p}_{101} + {p}_{100} + {p}_{001} + {p}_{010} - {p}_{000}\right)$$

As can be seen from the above, interpolator 350 may perform many operators to generate an interpolated output CM color value. For instance, performing Equations 1 may involve 8 multiplication operations and 7 addition operations, Equations 2 may involve 3 division and 6 subtraction (addition) operations, and Equations 3 may involve 19 subtraction (addition) operations. Additionally, 8 memory reads may be involved for LUT 348 to provide the lattice points to interpolator 350.

Clock gating controller 352 may control operation of interpolator 350. For instance, interpolator 350 may operate based on a clock signal. Where the clock signal does not toggle, interpolator 350 may not operate. As discussed in further detail below, clock gating controller 352 may cause interpolator 350 to refrain from operating when an input color sample matches an entry in cache 344. As such, where the input color sample matches an entry in cache 344, interpolator 350 may refrain from interpolating the input color sample.

FIG. 4 is a conceptual diagram illustrating one example of a cache address decoder, in accordance with one or more techniques of this disclosure. Cache address decoder 442 may be an example of cache address decoder 342 of FIG. 3. As shown in FIG. 4, cache address decoder 442 may determine an address in a cache, such as cache 344 of FIG. 4, based on an input color sample. For instance, address generator 470 of cache address decoder 442 may determine a cache address based on the following Equation 4:

$$C a c h e a d d r e s s = B a s {e}_{a d d r e s s} - U p p e {r}_{t h} + O f f s e t 1 ∗ T h + O f f s e t 2$$

Base_{address} may be the R value, Offset1 may represent the G value minus the R value, and Offset2 may represent the B value minus the R value. Upperₜₕ and Th may be predetermined variables. As one example, where Upperₜₕ = 200 and Th = 3, address generator 470 may determine the cache address for an input color value with RGB of (200, 201, 202) as 5 (e.g., 5=200-200+1*3+2). Cache address decoder 442 may determine if an entry in the cache, e.g., cache 344, is a hit for the determined cache address. For instance, as shown in the example of FIG. 4, cache address decoder 442 may determine that there is a hit because there is that an entry in the cache matches the determined cache address of 5. For simplicity, the output RGB in FIG. 4 is denoted as a function of the input RGB values, in operation the cache would store the actual interpolated RGB value that corresponds to the input RGB value.

Referring now to FIG. 3, as discussed above, the entries in the cache may be static and predetermined. For instance, an analysis of processed color samples may be conducted (external to device 100) to determine the N most commonly used color samples. The N most commonly color samples, along with precalculated corresponding interpolated output color samples, may be stored in the cache, such as in cache 344.

FIG. 5 is a conceptual diagram showing details of one example of a CM & interpolator with dynamic cache updating, in accordance with one or more techniques of this disclosure. CM & interpolator 540 of FIG. 5 may be one example of CM & interpolator 240 of FIG. 2. As shown in FIG. 5, CM & interpolator 540 may include cache address decoder 542, cache 544, multiplexer 546, look-up table (LUT) 548, interpolator 550, and clock gating controller 552, each of which may respectively perform operations similar to cache address decoder 342, cache 344, multiplexer 346, LUT 348, interpolator 350, and clock gating controller 352 of FIG. 3. As also shown in FIG. 5, CM & interpolator 540 may include cache updater 556.

Cache updater 556 may perform one or more operations to update the entries of cache 544 based on images being processed or images previously processed by CM & interpolator 540. By updating the entries of cache 544 based on such image data, cache updater 556 may increase a probability that an entry of cache 544 will be a hit (e.g., match) an input color sample, which may reduce power consumption of CM & interpolator 540 due to being able to avoid performing interpolation for the input color sample.

In operation, cache address decoder 542 may receive color samples of a current line of color samples. Cache address decoder 542 may determine, for each respective color sample of the received color samples, whether there is a hit in cache 544 (e.g., determine whether cache 544 includes a respective matching entry).

Cache updater 556 may determine a quantity of input color samples of the current line of samples for which cache 544 includes corresponding entries. This quantity may be referred to as a hit rate. Cache updater 556 may determine whether to update entries of cache 544 based on the hit rate. For instance, responsive to determining that the hit rate does not satisfy a threshold hit rate, cache updater 556 may determine to update the entries of cache 544. Similarly, responsive to determining that the hit rate does satisfy the threshold hit rate, cache updater 556 may determine to not update the entries of cache 544. In some examples, cache updater 556 may determine that the hit rate does not satisfy the threshold hit rate where the hit rate is less than, or less than or equal to, the threshold hit rate.

In some examples, responsive to determining to update the entries of cache 544, cache updater 556 may update the entries of cache 554 based on the input color samples of the current line of samples. For instance, cache updater 556 may cause LUT 548 and interpolator 550 to perform interpolation on a plurality of input color samples of the current line of samples to obtain a plurality of output interpolated color samples. MUX 546 may provide the plurality of output interpolated color samples to a subsequent block of an image processing pipeline (e.g., regamma 242 of FIG. 2) and cache updater 556 may insert, into cache 544, entries mapping the plurality of input color samples to the plurality of output interpolated color samples. In some examples, cache updater 556 may insert the new entries in addition to entries that were previously in cache 544. In other examples, cache updater 556 may “clear out” cache 544 by removing entries from cache 544 prior to inserting the entries mapping the plurality of input color samples to the plurality of output interpolated color samples.

Cache address decoder 542 may utilize the updated entries of cache 544 when processing a subsequent line (e.g., a next line) of input color samples. As adjacent lines of color samples may have relatively high correlation in terms of common color values, updating the entries of cache 544 in the manner described above may increase the probability that cache 544 will include entries that match samples of the subsequent line of input color samples.

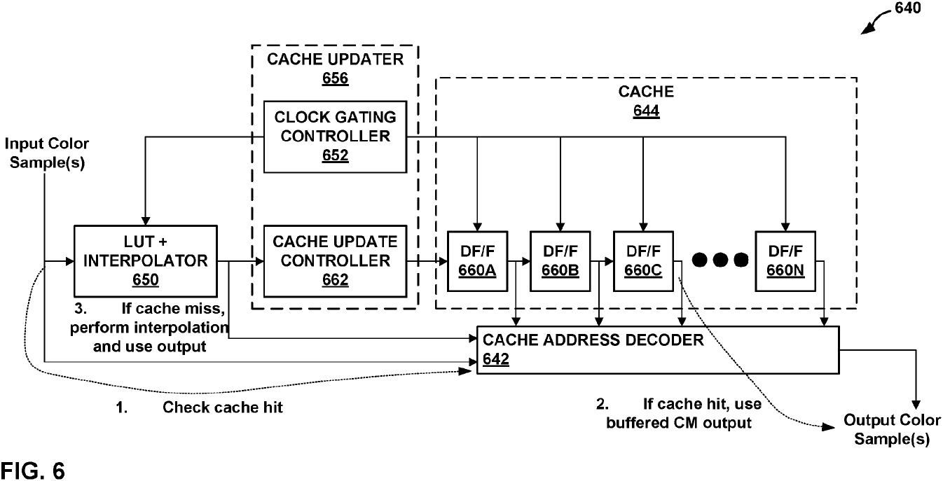

FIG. 6 is a conceptual diagram showing further details of one example of a CM & interpolator with dynamic cache updating, in accordance with one or more techniques of this disclosure. CM & interpolator 640 of FIG. 6 may be one example of CM & interpolator 540 of FIG. 5. As shown in FIG. 6, CM & interpolator 640 may include cache address decoder 642, cache 644, look-up table (LUT) + interpolator 650, and cache updater 656. Cache address decoder 642 and cache 644 may respectively perform operations similar to cache address decoder 542 and cache 544 of FIG. 5. LUT + interpolator 650 may perform operations similar to a combined LUT 548 and interpolator 550 of FIG. 5.

As shown in FIG. 6, cache 644 may include a plurality of memory elements, shown as D flip flops 660A-660N (collectively “D flip flops 660”), that each store an entry (i.e., an entry mapping an input color sample to an output interpolated color sample). Clock gating controller 552 may control operation of D flip flops 660 such that new entries are stored at D flip flops 660 when cache updater 656 updates the entries.

Cache updater 656 may include clock gating controller 652 and cache update controller 662. Clock fating controller 652 may selectively output clock signals (or may control the outputting of clock signals by other components) to manage the flow and processing of color samples by components of CM & interpolator 640. Cache update controller 662 may analyze operations of CM & interpolator 640 to determine when to perform updates of entries stored in cache 644. As discussed above, cache update controller 662 may determine to perform an update of the entries in cache 644 responsive to determining that hit rate does not satisfy a threshold hit rate.

In operation and as shown in FIG. 6, cache address decoder 642 may determine whether there is a cache hit for an input color sample. If there is a cache hit, cache address decoder 642 may output the buffered CM output (i.e., the interpolated color value stored in the D flip flop of D flip flops 660 that corresponds to the input color sample). However, if there is not a cache hit (i.e., if there is a cache miss), cache updater 656 may cause LUT + interpolator 650 to perform interpolation to generate an interpolated output color value for the input color value, which may be passed through cache address decoder 642 as the output color sample.

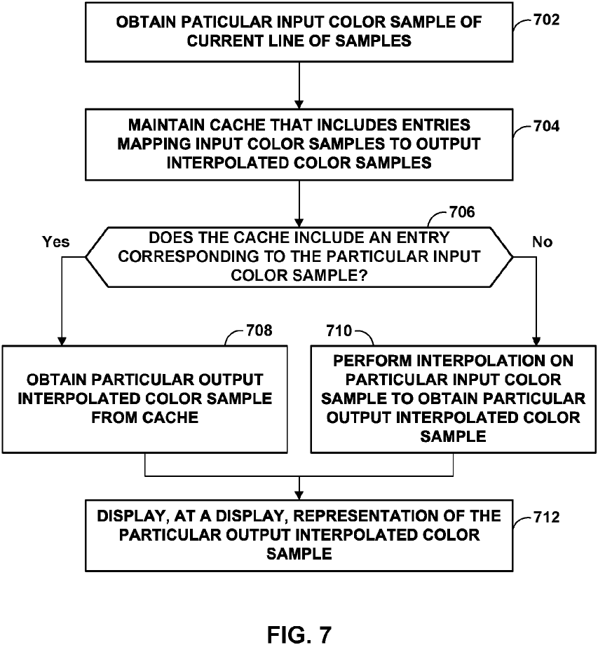

FIG. 7 is a flowchart illustrating example operations of an image processing pipeline that uses a cache to reduce power consumption of CM, in accordance with or more techniques of this disclosure. The operations of FIG. 6 are described within the context of CM & interpolator 240 of image processing pipeline 204 of FIG. 2, however the operations of FIG. 6 may be performed by other components.

CM & interpolator 240 may obtain a particular input color sample of a current line of samples (702). For instance, GPU 218 of image processing pipeline 204 may render a frame of image data as a matrix of color samples. The rendered color samples may be processed by prior components of image processing pipeline 204 (e.g., hue & saturation control 220 and degamma 222) and be provided to CM & interpolator 240.

CM & interpolator 240 may maintain a cache that includes entries mapping input color samples to output interpolated color samples (704). For instance, CM & interpolator 340 may maintain cache 344 or CM & interpolator 440 may maintain cache 444. As discussed above, the entries in the cache maintained by CM & interpolator 240 may be static or may be dynamically updated.

CM & interpolator 240 may determine whether the cache includes an entry corresponding to the particular input color sample (706). For instance, cache address decoder 342/442 may generate a cache address based on a value of the particular input color sample. Cache address decoder 342/442 may determine whether cache 344/444 includes an entry having the determined cache address.

Responsive to determining that the cache includes an entry corresponding to the particular input color sample (“Yes” branch of 706), CM & interpolator 240 may obtain a particular interpolated output color sample from the cache that is included in the entry corresponding to the particular input color (708). In such cases, CM & interpolator 240 may avoid having to perform interpolation on the particular input color sample.

Responsive to determining that the cache includes an entry corresponding to the particular input color sample (“No” branch of 706), CM & interpolator 240 may perform interpolation on the particular input color sample to obtain the particular output interpolated color sample (710). For instance, interpolator 350/450 may use values obtained from LUT 348/448 to perform trilinear interpolation on the particular input color sample to obtain the particular output interpolated color sample.

CM & interpolator 240 may provide the output interpolated color sample, whether obtained from the cache (708) or interpolated (710), to a subsequent block of image processing pipeline. Eventually, regardless of whether or not additional processing is performed on the output interpolated color sample, a representation of the output interpolated color sample may be displayed at a display (712).

The following numbered examples may illustrate one or more aspects of this disclosure:

Example 1. A method comprising: obtaining, by processing circuitry of a display image processing pipeline of a device, a particular input color sample of a current line of samples rendered by a graphical processing unit of the device; maintaining, by the processing circuitry, a cache that includes entries mapping input color samples to output interpolated color samples; determining, by the processing circuitry, whether the cache includes an entry corresponding to the particular input color sample; responsive to determining that the cache includes an entry corresponding to the particular input color sample, outputting, by the processing circuitry, a particular output interpolated color sample included in the entry corresponding to the particular input color sample without performing interpolation on the particular input color sample; and displaying, at a display of the device, a representation of the particular output interpolated color sample.

Example 2. The method of example 1, further comprising: responsive to determining that the cache does not include an entry corresponding to the particular input color sample, performing interpolation on the particular input color sample to obtain the particular output interpolated color sample.

Example 3. The method of any of examples 1 or 2, where performing interpolation comprises performing trilinear interpolation using a three-dimensional look-up table.

Example 4. The method of any of examples 1-3, wherein the entries included in the cache are static and predetermined.

Example 5. The method of any of examples 1-3, wherein maintaining the cache comprises dynamically updating the entries of the cache.

Example 6. The method of example 5, wherein dynamically updating the entries of the cache comprises: determining a hit rate for input color samples of the current line of samples, wherein the hit rate includes a quantity of the input color samples of the current line of samples for which the cache includes corresponding entries; and responsive to determining that the hit rate is does not satisfy a threshold hit rate, updating the entries of the cache based on the input color samples of the current line of samples.

Example 7. The method of example 6, wherein updating the entries of the cache based on the input color samples of the current line of samples comprises: performing interpolation on a plurality of input color samples of the current line of samples to obtain a plurality of output interpolated color samples; and inserting, into the cache, entries mapping the plurality of input color samples to the plurality of output interpolated color samples.

Example 8. The method of example 7, wherein updating the entries of the cache based on the input color samples of the current line of samples further comprises: removing entries from the cache prior to inserting the entries mapping the plurality of input color samples to the plurality of output interpolated color samples.

Example 9. The method of any of examples 1-8, wherein the processing circuitry is included in a system on a chip that also includes the graphical processing unit.

Example 10. The method of any of examples 1-8, wherein the processing circuitry is included in a display driver integrated circuit that is different than a system on a chip that includes the graphical processing unit.

Example 11. The method of any of examples 1-10, wherein the display comprises an organic light emitting diode display.

Example 12. A device comprising: a display; and an image processing pipeline comprising circuitry configured to: obtain a particular input color sample of a current line of samples rendered by a graphical processing unit of the device; maintain a cache that includes entries mapping input color samples to output interpolated color samples; determine whether the cache includes an entry corresponding to the particular input color sample; output, responsive to determining that the cache includes an entry corresponding to the particular input color sample, a particular output interpolated color sample included in the entry corresponding to the particular input color sample without performing interpolation on the particular input color sample; and cause the display to output a representation of the particular output interpolated color sample.

Example 13. The device of example 12, wherein the circuitry is further configured to: perform, responsive to determining that the cache does not include an entry corresponding to the particular input color sample, interpolation on the particular input color sample to obtain the particular output interpolated color sample.

Example 14. The device of any of examples 12 or 13, wherein, to perform interpolation, the circuitry is configured to perform trilinear interpolation using a three-dimensional look-up table.

Example 15. The device of any of examples 12-14, wherein the entries included in the cache are static and predetermined.

Example 16. The device of any of examples 12-14, wherein, to maintain the cache, the circuitry is configured to dynamically update the entries of the cache.

Example 17. The device of example 16, wherein, to dynamically update the entries of the cache, the circuitry is configured to: determine a hit rate for input color samples of the current line of samples, wherein the hit rate includes a quantity of the input color samples of the current line of samples for which the cache includes corresponding entries; and update, responsive to determining that the hit rate is does not satisfy a threshold hit rate, the entries of the cache based on the input color samples of the current line of samples.

Example 18. The device of example 17, wherein, to update the entries of the cache based on the input color samples of the current line of samples, the circuitry is configured to: perform interpolation on a plurality of input color samples of the current line of samples to obtain a plurality of output interpolated color samples; and insert, into the cache, entries mapping the plurality of input color samples to the plurality of output interpolated color samples.

Example 19. The device of example 18, wherein, to update the entries of the cache based on the input color samples of the current line of samples, the circuitry is further configured to: remove entries from the cache prior to inserting the entries mapping the plurality of input color samples to the plurality of output interpolated color samples.

Example 20. The device of any of examples 12-19, wherein the circuitry is included in a system on a chip that also includes the graphical processing unit.

Example 21. The device of any of examples 12-19, wherein the circuitry is included in a display driver integrated circuit that is different than a system on a chip that includes the graphical processing unit.

Example 22. The device of any of examples 12-21, wherein the display comprises an organic light emitting diode display.

Example 23. A computer-readable storage medium storing instructions that, when executed, cause one or more processors of an image processing pipeline to perform the method of any of examples 1-8.

Example 24. A device comprising: a display; and means for performing the method of any of examples 1-8.

Example 25. Any combination of examples 1-24.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects have been described in this disclosure. These and other aspects are within the scope of the following claims.

1. A method comprising:
obtaining, by processing circuitry of a display image processing pipeline of a device, a particular input color sample of a current line of samples rendered by a graphical processing unit of the device;
maintaining, by the processing circuitry, a cache that includes entries mapping input color samples to output interpolated color samples;
determining, by the processing circuitry, whether the cache includes an entry corresponding to the particular input color sample;
responsive to determining that the cache includes an entry corresponding to the particular input color sample, outputting, by the processing circuitry, a particular output interpolated color sample included in the entry corresponding to the particular input color sample without performing interpolation on the particular input color sample; and
displaying, at a display of the device, a representation of the particular output interpolated color sample.

2. The method of claim 1, further comprising:
responsive to determining that the cache does not include an entry corresponding to the particular input color sample, performing interpolation on the particular input color sample to obtain the particular output interpolated color sample.

3. The method of claim 1 , where performing interpolation comprises performing trilinear interpolation using a three-dimensional look-up table.

4. The method of claim 1 , wherein the entries included in the cache are static and predetermined.

5. The method of claim 1 , wherein maintaining the cache comprises dynamically updating the entries of the cache.

6. The method of claim 5, wherein dynamically updating the entries of the cache comprises:
determining a hit rate for input color samples of the current line of samples, wherein the hit rate includes a quantity of the input color samples of the current line of samples for which the cache includes corresponding entries; and
responsive to determining that the hit rate is does not satisfy a threshold hit rate, updating the entries of the cache based on the input color samples of the current line of samples.

7. The method of claim 6, wherein updating the entries of the cache based on the input color samples of the current line of samples comprises:
performing interpolation on a plurality of input color samples of the current line of samples to obtain a plurality of output interpolated color samples; and
inserting, into the cache, entries mapping the plurality of input color samples to the plurality of output interpolated color samples.

8. The method of claim 7, wherein updating the entries of the cache based on the input color samples of the current line of samples further comprises:
removing entries from the cache prior to inserting the entries mapping the plurality of input color samples to the plurality of output interpolated color samples.

9. The method of claim 1 , wherein the processing circuitry is included in a system on a chip that also includes the graphical processing unit.

10. The method of claim 1 , wherein the processing circuitry is included in a display driver integrated circuit that is different than a system on a chip that includes the graphical processing unit.

11. The method of claim 1 , wherein the display comprises an organic light emitting diode display.

12. A device comprising:
a display; and
an image processing pipeline comprising circuitry configured to:
obtain a particular input color sample of a current line of samples rendered by a graphical processing unit of the device;
maintain a cache that includes entries mapping input color samples to output interpolated color samples;
determine whether the cache includes an entry corresponding to the particular input color sample;
output, responsive to determining that the cache includes an entry corresponding to the particular input color sample, a particular output interpolated color sample included in the entry corresponding to the particular input color sample without performing interpolation on the particular input color sample; and
cause the display to output a representation of the particular output interpolated color sample.

13. A computer-readable storage medium storing instructions that, when executed, cause one or more processors of an image processing pipeline of a device to:
obtain a particular input color sample of a current line of samples rendered by a graphical processing unit of the device;
maintain a cache that includes entries mapping input color samples to output interpolated color samples;
determine whether the cache includes an entry corresponding to the particular input color sample;
output, responsive to determining that the cache includes an entry corresponding to the particular input color sample, a particular output interpolated color sample included in the entry corresponding to the particular input color sample without performing interpolation on the particular input color sample; and
cause a display of the device to output a representation of the particular output interpolated color sample.

14. (canceled)

15. The device of claim 12, wherein the circuitry is further configured to:
perform, responsive to determining that the cache does not include an entry corresponding to the particular input color sample, interpolation on the particular input color sample to obtain the particular output interpolated color sample.

16. The device of claim 12, wherein, to maintain the cache, the circuitry is configured to dynamically update the entries of the cache.

17. The device of claim 16, wherein, to dynamically update the entries of the cache, the circuitry is configured to
determine a hit rate for input color samples of the current line of samples, wherein the hit rate includes a quantity of the input color samples of the current line of samples for which the cache includes corresponding entries; and
update, responsive to determining that the hit rate is does not satisfy a threshold hit rate, the entries of the cache based on the input color samples of the current line of samples.

18. The device of claim 17, wherein, to update the entries of the cache based on the input color samples of the current line of samples, the circuitry is configured to:
perform interpolation on a plurality of input color samples of the current line of samples to obtain a plurality of output interpolated color samples; and
insert, into the cache, entries mapping the plurality of input color samples to the plurality of output interpolated color samples.

19. The device of claim 18, wherein, to update the entries of the cache based on the input color samples of the current line of samples, the circuitry is configured to:
remove entries from the cache prior to inserting the entries mapping the plurality of input color samples to the plurality of output interpolated color samples.

20. The device of claim 12, wherein the processing circuitry is included in a display driver integrated circuit that is different than a system on a chip that includes the graphical processing unit.

21. The device of claim 12, wherein the display comprises an organic light emitting diode display.
